(19) United States
(12) Patent Application Publication
(10) Pub. No.: US 2025/0336051 A1
(43) Pub. Date: Oct. 30, 2025

(54) SENSOR USING STRUCTURE COLOR AND METHOD FOR MANUFACTURING SENSOR USING STRUCTURE COLOR

(71) Applicant: KOREA INSTITUTE OF MACHINERY & MATERIALS, Daejeon (KR)

(72) Inventors: Jaesung YOON, Daejeon (KR); Hoang Minh Nguyen, Daejeon (KR); Yeong-Eun YOO, Seoul (KR); Kwanoh KIM, Sejong-si (KR); Do Hyun KANG, Seoul (KR)

(21) Appl. No.: 18/930,311

(22) Filed: Oct. 29, 2024

(30) Foreign Application Priority Data
Apr. 29, 2024 (KR) 10-2024-0056861

(51) Int. Cl. G06T 7/00; G01B 11/16; G06T 7/90

(52) U.S. Cl. CPC G06T 7/0004; G01B 11/16; G06T 7/90; G06T 2207/10024; G06T 2207/30148

(57) ABSTRACT

Provided is a sensor using a structural color including a flexible substrate including micropatterns on a surface thereof, an imaging module configured to photograph the micropatterns to obtain a color image, and a determination module configured to determine a degree of stretching of the flexible substrate with the obtained color image when the flexible substrate is stretched, wherein the flexible substrate includes a first area in which intervals between the micropatterns are maintained constant when the flexible substrate is stretched, and a second area in which intervals between the micropatterns are increased when the flexible substrate is stretched, and the determination module is configured to determine the degree of stretching of the flexible substrate from a change in structural color of the second area based on a structural color of the first area.

### CROSS-REFERENCE TO RELATED APPLICATION

This application is based on and claims priority under 35 USC § 119 to Korean Patent Application No. 10-2024-0056861, filed on Apr. 29, 2024, in the Korean Intellectual Property Office, the disclosure of which is incorporated by reference herein in its entirety.

### BACKGROUND

### 1. Field

The present disclosure relates to a sensor using a structural color and a method of manufacturing the sensor using the structural color, and more specifically, to a sensor using a structural color in which a degree of stretching of a substrate is identified from a change in structural color that occurs due to a change in micropatterns when a flexible substrate on which the micropatterns forming a structural color is formed is stretched, and a method of manufacturing the sensor using the structural color.

### 2. Description of the Related Art

A structural color is a color that appears in the feathers of peacocks and the wings of butterflies and is made when light is reflected, scattered, or diffracted due to micro-or nano-scale micropattern structures on the surface. In general, colors that are made with pigments or dyes appear due to pigment molecules reflecting only a specific color and absorbing the rest, and in this way, a color generated by chemical components is referred to as a “chemical color.” Meanwhile, a structural color is a “physical color” that is a color made due to a physical structure affecting light.

Structural color sensors, which detect changes in physical quantities using a structural color, are known. Structural color sensors are formed in a form in which regular micropatterns are formed on a surface of a flexible substrate that is deformed when a tensile force is applied or when external environmental conditions such as temperature or humidity are changed. When a flexible substrate is deformed, intervals between micropatterns are changed, and thus a structural color changes. A structural color sensor detects a degree of stretching of the flexible substrate by using a change in color.

For example, when the substrate is deformed according to a temperature, the structural color sensor may be used as a temperature sensor, when the substrate is deformed according to humidity, the structural color sensor may be used as a humidity sensor, and when the substrate is deformed by a tensile force, the structural color sensor may be used as a strain sensor. However, a structural color may change according to a view angle at which the structural color is observed by a camera or the human eye and an incidence angle of visible light irradiated onto micropatterns.

### SUMMARY

The present disclosure is directed to providing a sensor using a structural color in which, in order to identify an initial structural color of a structural color that is changed according to a view angle or an angle of a light source, an initial structural color expression portion in which a structural color is not changed even when a flexible substrate is stretched is formed on the flexible substrate separately from a structural color sensor portion.

The problems to be solved by the present invention are not limited to the above-described problems, and any other problems not described herein will be clearly understood from the following description by those of ordinary skill in the art.

An embodiment of the present disclosure provides a sensor using a structural color including a flexible substrate including micropatterns on a surface thereof, an imaging module configured to photograph the micropatterns to obtain a color image, and a determination module configured to determine a degree of stretching of the flexible substrate with the obtained color image when the flexible substrate is stretched, wherein the flexible substrate includes a first area in which intervals between the micropatterns are maintained constant when the flexible substrate is stretched, and a second area in which intervals between the micropatterns are increased when the flexible substrate is stretched, and the determination module is configured to determine the degree of stretching of the flexible substrate from a change in structural color of the second area based on a structural color of the first area.

In an embodiment, the micropatterns may be formed by arranging microparticles in a monolayer.

In an embodiment, before the flexible substrate is stretched, the intervals between the microparticles of the first area may be equal to the intervals between the microparticles of the second area.

In an embodiment, the sensor may further include a metal layer between the microparticles arranged in the monolayer and the flexible substrate.

In an embodiment, the metal layer may include at least one selected from chromium, nickel, copper, aluminum, gold, and silver.

In an embodiment, a thickness of the metal layer may be in a range of 50 nm to 200 nm.

In an embodiment, in the first area, the metal layer may be continuously connected and attached to the microparticles, and in the second area, the metal layer may be attached to each of the microparticles.

In an embodiment, a size of the microparticles of the first area may be greater than a size of the microparticles of the second area.

In an embodiment, the first area and the second area may be arranged perpendicular to a stretching direction of the flexible substrate.

In an embodiment, the flexible substrate may include at least one selected from polydimethylsiloxane (PDMS), polyimide, polyethylene terephthalate (PET), hydrogel, and ecoflex.

Another embodiment of the present disclosure provides a method of manufacturing a sensor using a structural color, the method including arranging microparticles in a monolayer on a substrate, forming a metal layer on the microparticles, and forming the microparticles on a surface of a flexible substrate by transferring the microparticles onto a first area and a second area of the flexible substrate using the metal layer as an adhesive layer, wherein the metal layer is continuously connected and attached to the microparticles in the first area, and when the flexible substrate is stretched, intervals between the microparticles to which the metal layer is continuously connected and attached are maintained constant.

In an embodiment, when the flexible substrate is stretched, the intervals between the microparticles transferred onto the second area may increase.

In an embodiment, in the second area, the metal layer may be attached to each of the microparticles.

In an embodiment, the method may further include, prior to the forming of the metal layer, etching the microparticles transferred onto the second area.

In an embodiment, before the flexible substrate is stretched, the intervals between the microparticles of the first area may be equal to the intervals between the microparticles of the second area.

In an embodiment, the metal layer may include at least one selected from chromium, nickel, copper, aluminum, gold, and silver.

In an embodiment, a thickness of the metal layer may be in a range of 50 nm to 200 nm.

In an embodiment, the first area and the second area may be arranged perpendicular to a stretching direction of the flexible substrate.

In an embodiment, a size of the microparticles of the first area may be greater than a size of the microparticles of the second area.

In an embodiment, the microparticles may be simultaneously or sequentially transferred onto the first area and the second area.

### BRIEF DESCRIPTION OF THE DRAWINGS

FIG. 1 is a schematic view illustrating a configuration of a sensor using a structural color according to an embodiment of the present disclosure;

FIG. 2 is an experimental image showing that a structural color changes according to a view angle;

FIG. 3 is a graph showing a change in structural color according to an angle of a light source, a view angle, and stretching for micropatterns having a certain pattern period;

FIG. 4 is a schematic plan view illustrating an example of a sensor module of the sensor using the structural color of FIG. 1;

FIG. 5 shows graphs showing a change in structural color when a tensile force is applied to the sensor module of FIG. 4;

FIG. 6 shows schematic views illustrating an example of a method of manufacturing a first area of the sensor using the structural color of FIG. 1;

FIG. 7 shows schematic views illustrating an example of a method of manufacturing a second area of the sensor using the structural color of FIG. 1;

FIG. 8 shows views for describing a change when a tensile force is applied to the first area of the sensor using the structural color manufactured in FIG. 6;

FIG. 9 shows views for describing a change when a tensile force is applied to the second area of the sensor using the structural color manufactured in FIG. 6; and

FIG. 10 shows diagrams showing results of an experiment on a change in structural color according to a degree of stretching of a flexible substrate in a sensor using a structural color manufactured according to the present disclosure.

### DETAILED DESCRIPTION

Specific details of embodiments are included in the detailed description and drawings.

The advantages and features of the present disclosure and methods of accomplishing the same will become apparent from the following description of the embodiments in detail, taken in conjunction with the accompanying drawings. However, the present disclosure is not limited to the embodiments disclosed herein but will be implemented in various forms. The embodiments are provided so that the present disclosure is completely disclosed, and a person of ordinary skilled in the art can fully understand the scope of the present disclosure. Therefore, the present disclosure will be defined only by the scope of the appended claims. Like reference numerals refer to like elements throughout the specification.

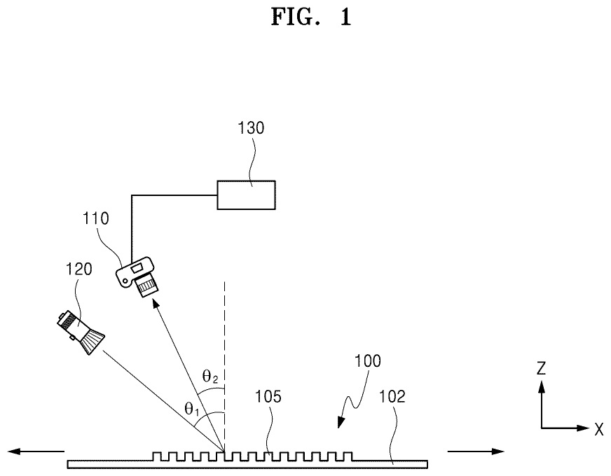

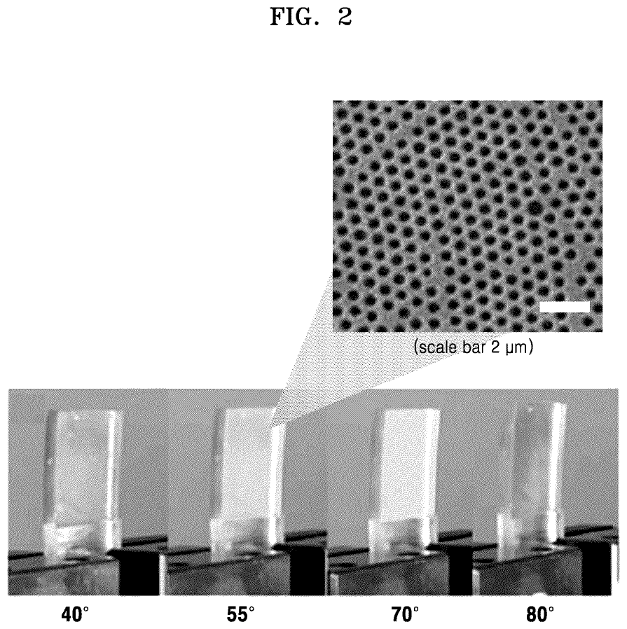

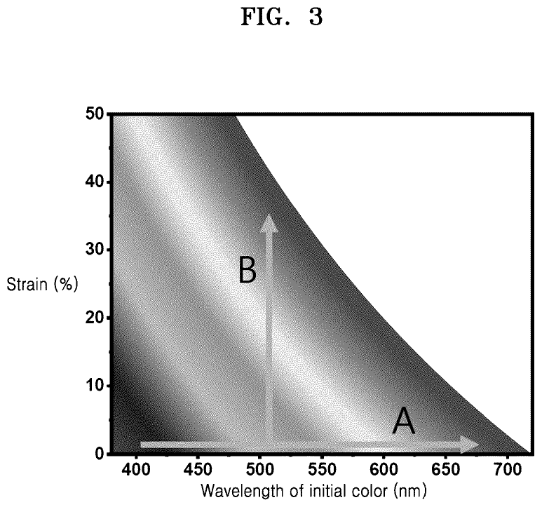

FIG. 1 is a schematic view illustrating a configuration of a sensor using a structural color according to an embodiment of the present disclosure, FIG. 2 is an experimental image showing that a structural color changes according to a view angle. FIG. 3 is a graph showing a change in structural color according to an angle of a light source, a view angle, and stretching for micropatterns having a certain pattern period.

Referring to FIG. 1, the sensor using the structural color may include a sensor module 100 including a flexible substrate 102, an image module 110, a light source 120, and a determination module 130.

The sensor module 100 may include the flexible substrate 102 that is flexible enough to be stretched or contracted and deformed due to changes in physical quantities such as external force, heat, and humidity.

The flexible substrate 102 may be a polymer substrate. For example, the flexible substrate 102 may be made of a polymer material including at least one selected from polydimethylsiloxane (PDMS), polyimide, polyethylene terephthalate (PET), hydrogel, and ecoflex.

The flexible substrate 102 may be deformed by being stretched by an external force or an external environment. For example, the flexible substrate 102 may be deformed in at least one direction of a first direction and a second direction. That is, the flexible substrate 102 may be deformed only in the first direction, for example, an X direction, only in the second direction, for example, a Y direction, or simultaneously in the first and second directions. In this case, the first direction and the second direction may be defined as directions intersecting each other on the same plane. In some embodiments, a portion of the flexible substrate 102 may be subjected to a strain in a positive direction of the first direction, for example, in a right direction on an X-axis coordinate, and another portion of the flexible substrate 102 may be subjected to a strain in a negative direction of the first direction, for example, in a left direction on the X-axis coordinate, so that shear deformation may be applied to the flexible substrate 102.

Micropatterns 105 may be formed on a surface of the flexible substrate 102 at certain intervals. The micropatterns 105 may be arranged at certain intervals to generate a structural color.

The micropatterns 105 are formed on the surface of the flexible substrate 102 at certain intervals (period) to generate a structural color.

The micropatterns 105 may be a plurality of nano-or micro-scale grooves disposed in a grid pattern at certain intervals or a plurality of protruding nano-or micro-scale structures disposed in a grid pattern at certain intervals, but are not limited thereto as long as the micropatterns 105 may generate a structural color. For example, the micropatterns 105 may be formed by transferring nano-or micro-sized microparticles as described below.

Meanwhile, when the flexible substrate 102 is stretched, intervals between the micropatterns 105 may change, resulting in a change in a color of a structural color. Therefore, a physical force that stretches or contracts the flexible substrate 102 may be sensed by measuring a color of a structural color.

For example, when the flexible substrate 102 is stretched or contracted according to an external temperature, the sensor according to the present disclosure may be used as a temperature sensor, when the flexible substrate 102 is stretched or contracted according to external humidity, the sensor according to the present disclosure may be used as a humidity sensor, and when the flexible substrate 102 is stretched or contracted by an external force, the sensor according to the present disclosure may be used as a strain sensor.

The image module 110 is disposed above the sensor module 100 and obtains a color image by photographing the micropatterns 105 that generates a structural color. For example, the image module 110 may be a digital camera that generates a captured image into a digital image. An image captured by the image module 110 may be transmitted to the determination module 130 and analyzed.

The light source 120 may be disposed above the sensor module 100 to irradiate visible light toward the sensor module 100.

The determination module 130 analyzes a color of a structural color from the color image obtained by the image module 110 to determine a degree of stretching of the flexible substrate 102. The determination module 130 may be a microprocessor or a computer including an extension device, a storage device, a memory, or the like.

Meanwhile, a structural color is a color that is implemented by using the regular micropatterns 105 without a dye or a pigment. In general, a color of the structural color is determined by the intervals (periods) of the micropatterns 105. Here, the intervals (periods) of the micropatterns 105 refers a distance between centers of two adjacent micropatterns 105.

Accordingly, by detecting that when the flexible substrate 102 is stretched, the intervals of the micropatterns 105 change and thus a structural color changes, it is possible to sense a physical force such as a tensile force that is a deformation factor of the flexible substrate 102.

However, as shown in FIG. 2, a color of a structural color changes according to a view angle Θ₂ for the same micropatterns 105. In some embodiments, a color of a structural color also changes according to an angle Θ₁ of the light source 120 which is an angle at which visible light is irradiated toward the micropatterns 105 by the light source 120.

In some embodiments, a change in structural color is determined by the sum of sine values of two angles (the angle Θ₁ of the light source 120 and the view angle Θ₂) according to Expression 1 below.

Δλ=nd (sinΘ₁+sinΘ₂) [Equation 1]

Here, λ denotes a wavelength of a structural color, n denotes a refractive index of a substrate on which patterns are formed, and d denotes intervals (period) of micropatterns.

Therefore, as in the present disclosure, in a sensor using a structural color, it is necessary to minimize a deformation of color due to a change in an angle of a light source or a view angle or compensate for the deformation.

Accordingly, the determination module 130 may further increase sensing accuracy by determining a degree of stretching of the flexible substrate 102 in consideration of a change in structural color that changes according to an angle at which the light source 120 irradiates light toward the micropatterns 105 or a view angle of the image module 110.

For the micropatterns 105 having a certain pattern period, a change in structural color according to an angle of the light source 120, a view angle, and stretching may be expressed analytically or experimentally as shown in FIG. 3.

When the flexible substrate 102 is not stretched, a change according to an angle (more specifically, sinΘ₁+sinΘ₂) appears as a change along a X-axis line indicated by A in FIG. 3. In this case, when an initial structural color is determined according to an arbitrary angle (sinΘ₁+sinΘ₂), a color of a structural color changes in a Y-axis direction from a point of the initial structural color when the flexible substrate 102 is stretched and the micropatterns 105 are deformed. For example, when the initial structural color according to the arbitrary angle (sinΘ₁+sinΘ₂) in FIG. 3 is a color of an intersection between A and B, and when the flexible substrate 102 is stretched afterward, a change in structural color gradually changes from the intersection between A and B in a direction of B. Accordingly, through data about a distribution of a structural color as shown in FIG. 3, in consideration of a color of the initial structural color, the determination module 130 may accurately identify a degree of stretching of the flexible substrate 102 according to a change in structural color when the flexible substrate 102 is stretched.

Furthermore, in the present disclosure, since the flexible substrate 102 includes a first area in which a structural color does not change when the flexible substrate 102 is deformed and a second area in which a structural color changes when the flexible substrate 102 is deformed, even when it is not accurately identified which angles are respectively a view angle and an angle of the light source 120, sensing accuracy may be improved by reflecting the influence of a structural color that changes according to the view angle or the angle of the light source 120.

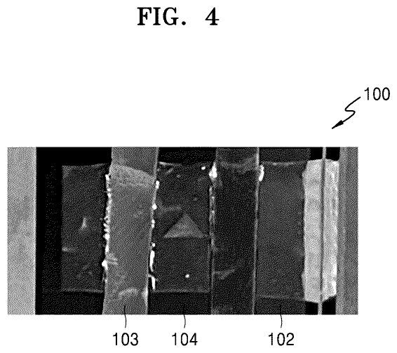

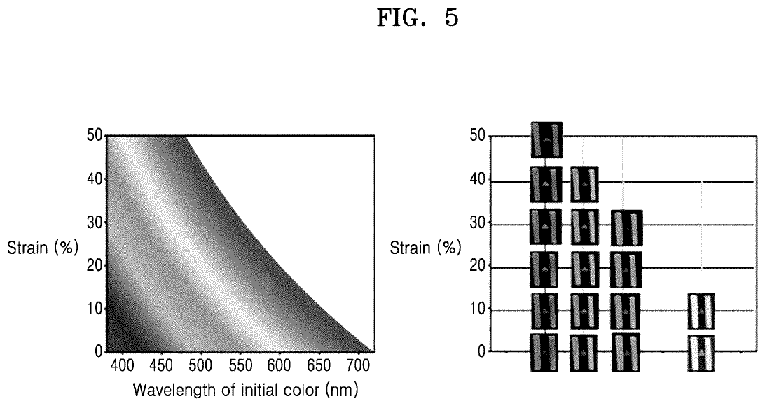

FIG. 4 is a schematic plan view illustrating an example of the sensor module 100 of the sensor using the structural color of FIG. 1. FIG. 5 shows graphs showing a change in structural color when a tensile force is applied to the sensor module 100 of FIG. 4.

Referring to FIG. 4, the flexible substrate 102 may include a first area 103 in which intervals between micropatterns are maintained constant when the flexible substrate 102 is stretched, and a second area 104 in which intervals between micropatterns are increased when the flexible substrate 102 is stretched. FIG. 4 illustrates an example in which the first area 10 is formed at each of opposite sides of the second areas 104, but one or more embodiments are not limited thereto.

For example, the micropatterns of the first area 103 and the second area 104 may be formed by arranging microparticles in a monolayer. In some embodiments, before the flexible substrate 102 is stretched, intervals between the microparticles of the first area 103 may be equal to intervals between the microparticles of the second area 104. Therefore, structural colors of the first area 103 and the second area 104 are the same before the flexible substrate 102 is stretched.

Here, the intervals between the microparticles may be an interval between centers of two adjacent microparticles. Therefore, even when sizes of the microparticles of the first area 103 and the microparticles of the second area 104 are different, when the intervals are equal to each other, the first area 103 and the second area 104 may exhibit the same structural color.

That is, the first area 103 may be formed to have the micropatterns having the intervals equal to those of the micropatterns formed in the second area 104, and the intervals between the micropatterns formed in the first area 103 may not be allowed to be changed when the flexible substrate 102 is stretched, thereby identifying an initial structural color according to a currently set view angle and an angle of the light source 120.

Referring to FIG. 5, it can be confirmed that when the flexible substrate 102 is stretched, a structural color of the second area 104 changes, but a structural color of the first area 103 does not change. In some embodiments, it can be confirmed that the structural colors of the first area 103 and the second area 104 before the flexible substrate 102 is stretched are the same, but the initial structural colors according to the view angle and the angle of the light source 120 are different according to an angle.

That is, even when the flexible substrate 102 is stretched, the first area 103 may maintain the initial structural color before the flexible substrate 102 is stretched, the image module 110 may photograph the structural color of the first area 103 and the structural color of the second area 104, and the determination module 130 may identify the initial structural color according to a current angle of the light source 120 and a view angle from the structural color of the first area 103 and may measure a degree of stretching, in which the initial structural color is reflected, from the structural color of the second area 104 as described with reference to FIG. 3.

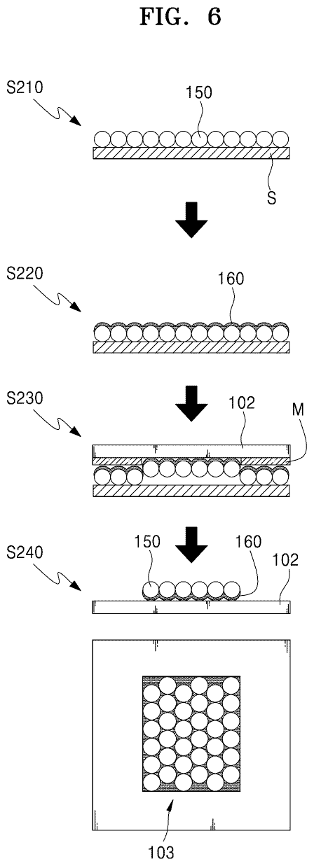

Hereinafter, the characteristics of micropattern structures in which the structural color of the first area 103 does not change even when the flexible substrate 102 is stretched, and a method of manufacturing the same will be described with reference to FIGS. 6 to 10.

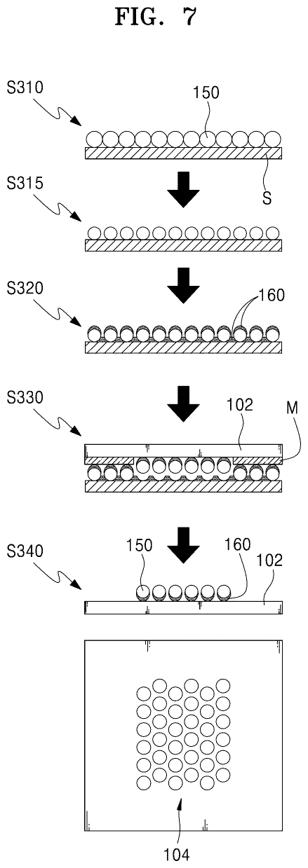

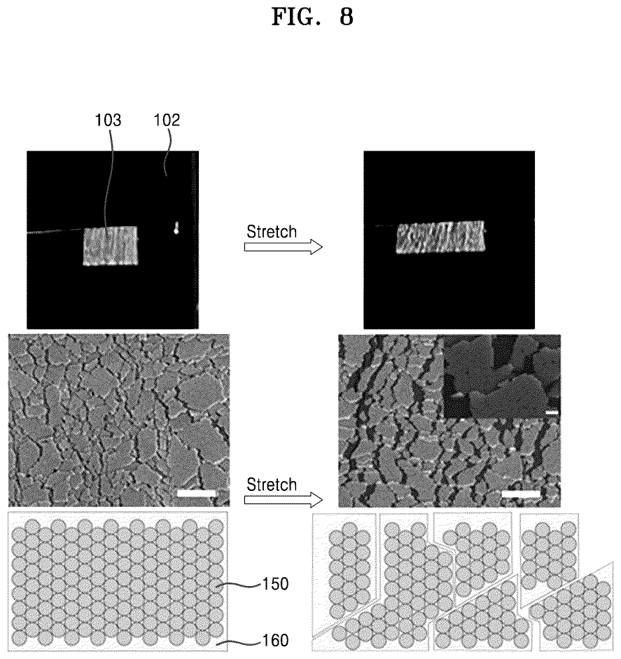

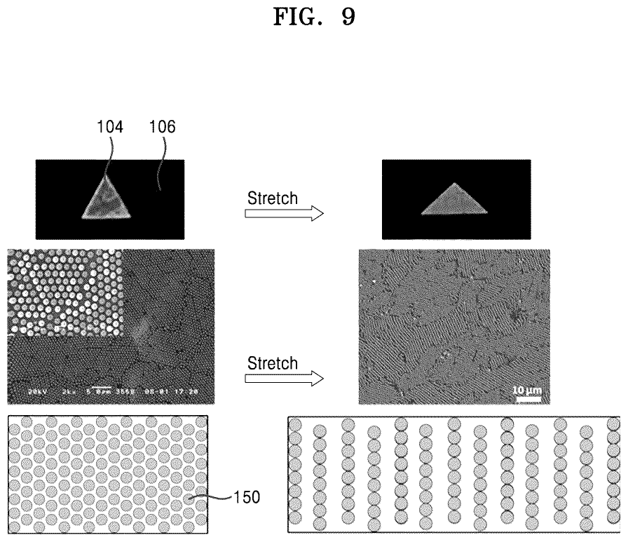

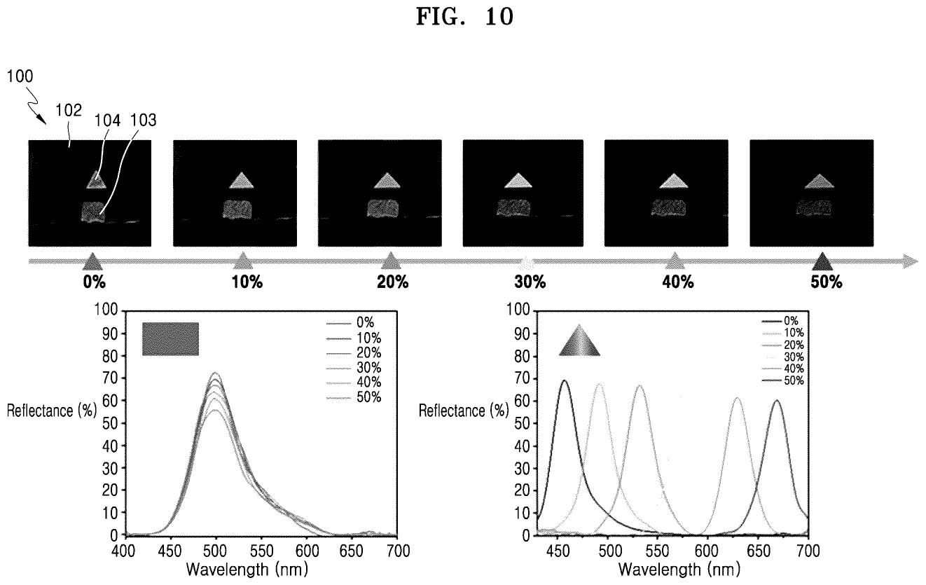

FIG. 6 shows schematic views illustrating an example of a method of manufacturing a first area of the sensor using the structural color of FIG. 1. FIG. 7 shows schematic views illustrating an example of a method of manufacturing a second area of the sensor using the structural color of FIG. 1. FIG. 8 shows views for describing a change when a tensile force is applied to the first area of the sensor using the structural color manufactured in FIG. 6. FIG. 9 shows views for describing a change when a tensile force is applied to the second area of the sensor using the structural color manufactured in FIG. 7. FIG. 10 shows diagrams showing results of an experiment on a change in structural color according to a degree of stretching of a flexible substrate in a sensor using a structural color manufactured according to the present disclosure.

A method of manufacturing a sensor module of a sensor using a structural color according to an embodiment of the present disclosure may include arranging microparticles 150 in a monolayer on a substrate S, forming a metal layer 160 on the microparticles 150, and forming the microparticles 150 on a surface of the flexible substrate S by transferring the microparticles 150 onto a first area 103 and a second area 104 of a flexible substrate 102 using the metal layer 160 as an adhesive layer.

Hereinafter, for convenience of description, the transferring of the microparticles 150 onto the first area 103 and the second area 104 will be described below, but the microparticles 150 may be simultaneously or sequentially transferred onto the first area 103 and the second area 104.

First, FIG. 6 illustrates the forming of the first area 103 on the flexible substrate 102.

The forming of the first area 103 will be described with reference to FIG. 6.

Referring to the drawing, the microparticles 150 are arranged in the monolayer on the substrate S (S210). For example, the microparticles 150 may include silica, polystyrene, or the like and may be nano-or micro-sized spherical particles. In this case, structural colors with different colors may be generated according to an interval between centers of the microparticles 150, and the microparticles 150 may be densely arranged without being spaced apart from each other.

The microparticles 150 with a nano-or micro-size may be arranged on the substrate S through a self-assembly method.

Specifically, 10% weight/volume of a polystyrene solution (manufactured by Bangs Laboratories, Inc.) having an average diameter of 780 nm and a triton as a surfactant are mixed in a volume ratio of 400:1, and a droplet is sprayed onto the substrate S to rotate the substrate S. The surfactant serves to delay an evaporation process while the droplet of the polystyrene solution is spinning and provide more time for polystyrene nanoparticles to be self-arranged in a large area of the monolayer. Types of the microparticles 150 arranged on the substrate S and a method of arranging the microparticles 150 are not limited to such a method, and other known methods may be used.

Next, the metal layer 160 is deposited on the arranged microparticles 150 (S220). The metal layer 160 may include at least one selected from chromium, nickel, copper, aluminum, gold, and silver. In some embodiments, the metal layer 160 may have a thickness of 50 nm to 200 nm.

Meanwhile, since the microparticles 150 are arranged not to be spaced apart from each other, when the metal layer 160 is deposited, the metal layer 160 may be continuously connected and formed on the microparticles 150.

For example, the metal layer 160 may be formed by depositing chromium (Cr). An e-beam evaporator may be used for a deposition method, but one or more embodiments are not necessarily limited thereto.

Next, the metal layer 160 is used as the adhesive layer to transfer the microparticles 150 onto the flexible substrate 102 (S230) to form the first area 103 on the flexible substrate 102 (S240). In this case, the microparticles 150 may be transferred onto the flexible substrate 102 by an adhesive force of the metal layer 160. Accordingly, the metal layer 160 may be positioned between the microparticles 150 arranged in the monolayer and the flexible substrate 102 and may be continuously connected and attached to a plurality of microparticles 150. In some embodiments, due to high reflectance of the metal layer 160, a color with high visibility may be implemented even in relatively dark environments.

In some embodiments, a mask M having a pattern with a certain shape formed thereon may be used such that the first area 103 is formed in a certain shape on the flexible substrate 102 during a transcription process.

FIG. 7 shows views illustrating forming the second area 104 on the flexible substrate 102. The forming of the second area 104 will be described with reference to FIG. 7.

First, the microparticles 150 are arranged in a monolayer on the substrate S (S310). In this case, a size of the microparticles 150 may be equal to a size of the microparticles 150 of the first area 103. A method of arranging the microparticles 150 in the monolayer on the substrate S is the same as that described above.

Next, the microparticles 150 are etched to allow the microparticles 150 to be spaced apart from each other (S315). For example, the size of the microparticles 150 may be reduced by using reactive ion etching (RIE) using plasma.

Next, the metal layer 160 is deposited on the arranged microparticles 150 (S320). Since the microparticles 150 are spaced apart from each other through etching, when the metal layer 160 is deposited on the microparticles 150, discontinuous metal layers 160 may be formed for the microparticles 150. That is, the metal layer 160 may be attached to each of the microparticles 150. The metal layer 160 may be formed by depositing, for example, chromium (Cr).

Next, the second area 104 may be formed at one side of the flexible substrate 102 (S340) by transferring the microparticles 150 onto the other side of the flexible substrate 102 on which the first area 103 is to be formed or formed (S330). In this case, the microparticles 150 may be transferred onto the flexible substrate 102 by an adhesive force of the metal layer 160. In some embodiments, a mask M having a pattern with a certain shape formed thereon may be used such that the second area 104 is formed in a certain shape at one side of the flexible substrate 102 during a transcription process.

A size of the microparticles 150 transferred through etching may be smaller than a size of the microparticles 150 transferred to form the first area 103, but since intervals between centers of the microparticles 150 are equal to each other, structural colors of the first area 103 and the second area 104 may be the same before the flexible substrate 102 is stretched.

Meanwhile, for convenience of description, processes of manufacturing the first area 103 and the second area 104 are described separately with reference to FIGS. 6 and 7, but a sensor module 100 may be manufactured by transferring the microparticles 150 onto each of one side and the other side of the same flexible substrate 102 as described above. In this case, the transcription order for forming the first area 103 and the second area 104 may be changed.

As shown in FIG. 8, since the metal layer 160 of the first area 103 is connected continuously, when the flexible substrate 102 is stretched, cracks occur in the metal layer 160, which causes a phenomenon in which the metal layer 160 is divided into local areas (islands) in which micropatterns are gathered.

For reference, the uppermost view of FIG. 8 illustrates structural colors of the first area 103 before and after stretching, wherein the first area 103 is actually manufactured in a quadrangular shape on the flexible substrate 102 through the above-described method, the middle view of FIG. 8 is an enlarged image for confirming whether cracks occur in the first area 103 before and after stretching, and the lowermost view of FIG. 8 is a drawing for describing a change in micropatterns before and after stretching.

A color of a structural color is determined according to intervals between microparticles 150. In the first area 103, the metal layer 160 is only divided into the local areas by cracks when the flexible substrate 102 is stretched, and intervals between the microparticles 150 are not changed within the local areas so that a structural color is not changed. Therefore, even when the flexible substrate 102 is stretched, even after deformation, the first area 103 may maintain an initial color before deformation.

For this purpose, the metal layer 160 may have a thickness of 50 nm to 200 nm. When the thickness of the metal layer 160 is less than 50 nm, cracks may too easily occur in the metal layer 160 when the flexible substrate 102 is stretched, which may make it difficult to form a local area. When the thickness of the metal layer 160 exceeds 200 nm, cracks may be prevented from occurring in the metal layer 160 when the flexible substrate 102 is stretched, which may cause the delamination of the metal layer 160.

Meanwhile, since the metal layers 160 of the second area 104 are formed discontinuously, as shown in FIG. 9, when the flexible substrate 102 is stretched, intervals between the microparticles 150 also increase in proportion to a degree of stretching of the flexible substrate 102. Accordingly, a structural color of the second area 104 changes according to the degree of stretching of the flexible substrate 102.

FIG. 10 shows diagrams a displacement sensor using a structural color manufactured according to a method according to the present disclosure and results of measuring displacement using the same. A first area 103 with a quadrangular shape and a second area 104 with a triangular shape were formed together on a flexible substrate 102.

It can be confirmed that when the flexible substrate 102 is stretched, a structural color of the first area 103 does not change irrespective of a degree of stretching, and only a structural color of the second area 104 changes.

In the first area 103, when microparticles 150 are transferred onto the flexible substrate 102 to form a pattern, each of the microparticles 150 is transferred onto the flexible substrate 102 by using the metal layer 160, which is continuously connected and formed, as an adhesive layer. As a result, when the flexible substrate 102 is stretched, cracks occur in the metal layer 16, and the metal layer 160 is divided into local areas, and intervals between the microparticles 150 within the local areas are maintained without any change. Thus, a structural color of the first area 103 does not change.

On the other hand, in the second area 104, the microparticles 150 are disposed to be spaced apart from each other by the metal layers 160 spaced apart from each other. Accordingly, when the flexible substrate 102 is stretched, intervals between the microparticles 150 may change, thereby changing a structural color of the second area 104.

Therefore, when the flexible substrate 102 is stretched, a degree of stretching of the flexible substrate 102 may be measured more accurately by comparing the structural color of the first area 103 with the structural color of the second area 104 and considering an initial structural color according to a view angle and an angle of a light source.

As described above, in a sensor module 100 of a sensor using a structural color according to the present disclosure, a first area 103 and a second area 104 may be formed together on a flexible substrate 102 so that an initial structural color and a changed structural color may be simultaneously confirmed when the flexible substrate 102 is stretched. Meanwhile, since a structural color due to micropatterns may change according to a view angle and an angle of a light source, as shown in FIG. 10. the first area 103 and the second area 104 are arranged perpendicular to a stretching direction of the flexible substrate 102, thereby minimizing changes in view angle and angle of the light source according to stretching of the flexible substrate 102.

The scope of the present disclosure is not limited to the above-described embodiments, but the present disclosure may be implemented in various forms of embodiments within the scope of the appended claims. A range in which anyone with ordinary skill in the art to which the present disclosure pertains can make various modifications without departing from the gist of the present disclosure claimed in the claims is considered to be within the scope of the claims of the present disclosure.

According to a sensor using a structural color and a method of manufacturing the sensor using the structural color according to the present disclosure as described above, in order to correct a change in structural color that changes according to a view angle or an angle of a light source, micropatterns in which a structural color changes according to stretching of a flexible substrate and micropatterns in which a structural color does not change irrespective of stretching of the flexible substrate are simultaneously formed on a flexible substrate, thereby accurately identifying a degree of stretching of the flexible substrate by comparing structural colors of two types of micropatterns.

In some embodiments, since microparticles are coupled to a flexible substrate by a metal layer to form micropatterns, a structural color may be easily observed even in an environment with a low light amount due to high reflectance of the metal layer.

What is claimed is:

1. A sensor using a structural color, comprising:
a flexible substrate comprising micropatterns on a surface thereof;
an imaging module configured to photograph the micropatterns to obtain a color image; and
a determination module configured to determine a degree of stretching of the flexible substrate with the obtained color image when the flexible substrate is stretched,
wherein the flexible substrate comprises a first area in which intervals between the micropatterns are maintained constant when the flexible substrate is stretched, and a second area in which intervals between the micropatterns are increased when the flexible substrate is stretched, and
the determination module is configured to determine the degree of stretching of the flexible substrate from a change in structural color of the second area, based on a structural color of the first area.

2. The sensor of claim 1, wherein the micropatterns are configured as a monolayer in which microparticles are arranged.

3. The sensor of claim 2, wherein, before the flexible substrate is stretched, the intervals between the microparticles of the first area are equal to the intervals between the microparticles of the second area.

4. The sensor of claim 2, further comprising a metal layer between the microparticles arranged in the monolayer and the flexible substrate.

5. The sensor of claim 4, wherein the metal layer comprises at least one selected from chromium, nickel, copper, aluminum, gold, and silver.

6. The sensor of claim 4, wherein a thickness of the metal layer is in a range of 50 nm to 200 nm.

7. The sensor of claim 4, wherein, in the first area, the metal layer is continuously connected and attached to the microparticles, and in the second area, the metal layer is attached to each of the microparticles.

8. The sensor of claim 2, wherein a size of the microparticles of the first area is greater than a size of the microparticles of the second area.

9. The sensor of claim 1, wherein the first area and the second area are arranged perpendicular to a direction in which the flexible substrate stretches.

10. The sensor of claim 1, wherein the flexible substrate comprises at least one selected from polydimethylsiloxane (PDMS), polyimide, polyethylene terephthalate (PET), hydrogel, and ecoflex.

11. A method of manufacturing a sensor using a structural color, the method comprising:
arranging microparticles in a monolayer on a substrate;
forming a metal layer on the microparticles; and
forming the microparticles on a surface of a flexible substrate by transferring the microparticles onto a first area and a second area of the flexible substrate using the metal layer as an adhesive layer;
wherein the metal layer is continuously connected and attached to the microparticles in the first area, and
when the flexible substrate is stretched, intervals between the microparticles to which the metal layer is continuously connected and attached are maintained constant.

12. The method of claim 11, wherein when the flexible substrate is stretched, the intervals between the microparticles transferred onto the second area are increased.

13. The method of claim 12, wherein, in the second area, the metal layer is attached to each of the microparticles.

14. The method of claim 11, further comprising, prior to the forming of the metal layer, etching the microparticles transferred onto the second area.

15. The method of claim 11, wherein, before the flexible substrate is stretched, the intervals between the microparticles of the first area are equal to the intervals between the microparticles of the second area.

16. The method of claim 11, wherein the metal layer comprises at least one selected from chromium, nickel, copper, aluminum, gold, and silver.

17. The method of claim 11, wherein a thickness of the metal layer is in a range of 50 nm to 200 nm.

18. The method of claim 11, wherein the first area and the second area are arranged perpendicular to a direction in which the flexible substrate stretches.

19. The method of claim 11, wherein a size of the microparticles of the first area is greater than a size of the microparticles of the second area.

20. The method of claim 11, wherein the microparticles are simultaneously or sequentially transferred onto the first area and the second area.
